(19) United States
(12) Patent Application Publication
(10) Pub. No.: US 2012/0072285 A1
(43) Pub. Date: Mar. 22, 2012

(54) System to improve response to radio advertising

(76) Inventor: L. Joseph Marhoefer, Reston, VA (US)

(21) Appl. No.: 12/925,152

(22) Filed: Oct. 15, 2010

Related U.S. Application Data
(60) Provisional application No. 61/403,797, filed on Sep. 22, 2010.

(51) Int. Cl. G06Q 30/00

(52) U.S. Cl. 705/14.55

(57) ABSTRACT

A system assigns, to an advertisement while it is running, a short, easily remembered code from a limited list of available codes. A listener or viewer can use the code access the web address and/or telephone number broadcast by the advertisement. The code is assigned to the advertisement. That is, when the advertisement stops being, the code associated with that advertisement is returned to the database of available codes and can be reassigned. A preferred embodiment of the invention relates to radio broadcasting. Here, the data base includes the broadcast station or stations that air the advertisement so that in reassigning a code (preferably an alpha numeric code), it is assigned to an advertisement running in a broadcast area that does not overlap with the broadcast area where it had been previously recently used.

This invention relates to a system to improve the response of listeners to radio advertisements, and more particularly to a system that makes it easy for a listener to access the advertiser's advertised telephone number and web site for additional information about the advertised product or service. This application claims priority of provisional application 61/403,797 filed Sep. 22, 2010.

### FIELD OF THE INVENTION

### Background of the Invention

It is common today for a radio advertisement to conclude with a URL web address and/or telephone number of the advertiser where the listener can learn more about the advertised product or service. The problem is that the web address and/or number are usually hard to remember and are also long so that it is difficult to accurately write down, or inter, even if remembered.

In the prior art the issue of long URLs has been addressed in a general way. As described in Wikipedia, Tiny URL™ is a URL shortening service, a web service that provides short aliases for redirection of long URLs. For each URL entered, the server adds a new alias in its hashed database and returns a short URL in the following page. If the URL had already been requested, the program will return the existing alias rather than create a duplicate. The aliases are seen as useful because they are easier to write down than the full URL, to remember. They are also used where space is limited such as IRC channel topics, email signatures, micro blogs certain printed newspapers, and people posting on Twitter.

U.S. Pat. No. 6,769,018 discloses a system that uses what the patent refers to as “jump codes” to access via the web data about a product or services. These jump codes are four or five characters long and are assigned as an alias for a URL address to a web site. The system uses a published list of preselected web sites. Each of the selected web sites is assigned a jump code. A user desiring to access one of the selected web sites, first accesses a special web site that contains software for receiving jump codes and, based on the stored relationship between the jump code and the URL of the desired published web site, directly access that web site. The '018 patent suggests that the same jump code could be use more once to access web sites with different URLs, but this requires first accessing different special web sites in order to prevent confusion.

The approach taken by Tiny URL and the '018 patent, while generally satisfactory for their intended applications, is not altogether satisfactory for radio broadcast advertisement applications. The approach of Tiny URL and similar web sites and the '018 patent is to use a four or five character alias with the assumption shorter is better. This prior art does not suggest a format that is easy to remember when heard or format that uses only three or less characters. In addition they do not even recognize the desirability of a web alias address for broadcast telephone numbers.

### SUMMARY OF THE INVENTION

An object of this invention is the provision of a system to improve the response to radio broad cast advertisements using a code to fetch the ads URL and/or phone number with a code format that facilitates recall, uses a character set with a limited number of characters, and provides reuse of a code with different ads.

Briefly, this invention contemplates the provision of a system that assigns to an advertisement while it is running a short, easily remembered code from a database of available codes. The code can be used by the listener to access the web address and/or telephone number broadcast by the ad. The code is assigned to the advertisement. That is, when the advertisement stops being aired on the radio, the code associated with that advertisement is returned to the database of available codes and can be reassigned. In a preferred embodiment of the invention the data base includes the broadcast station or stations that air the advertisement so that in reassigning an alpha numeric code, it is assigned to an advertisement running in a broadcast area that does not overlap with the broadcast area where it had been previously recently used.

### BRIEF DESCRIPTION OF THE DRAWINGS

FIG. 1 is a block diagram of one embodiment of a system to enhance the response of listeners of radio advertisements in accordance with the teachings of this invention.

FIGS. 2(a) and 2(b) are pectoral representations of the data fields in the databases files 16 and 18 respectively. FIG. 2) is illustrates the fields in the file 20 that includes the code, the number of requests per day over a running period (e.g. 14-day period) and the total cumulative requests to date.

FIG. 3 is a flow chart illustrating the steps in moving alphanumeric codes between database files 16 and 18.

FIG. 4 is a block diagram similar to FIG. 1 but has a database that has a table (group) of records with seven fields.

FIG. 5 is a pectoral representation of the record fields in FIG. 4.

### DETAILED DESCRIPTION OF THE INVENTION

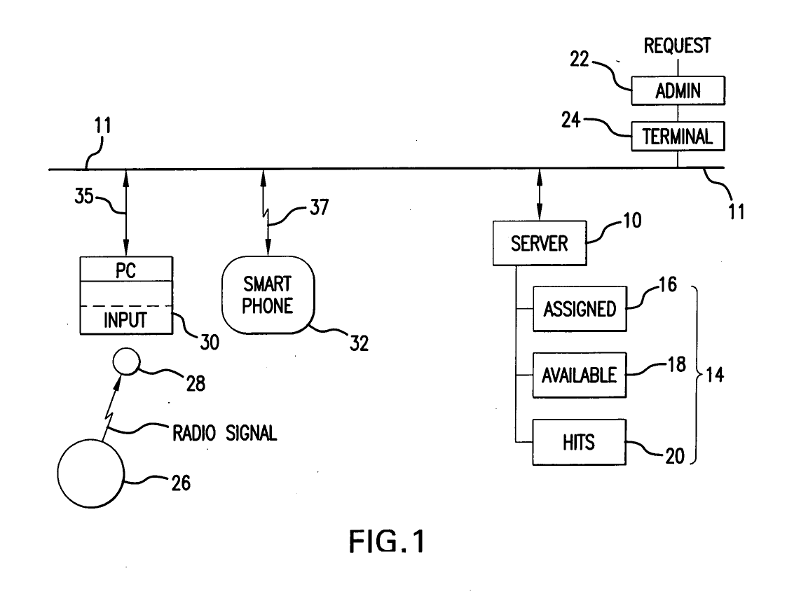

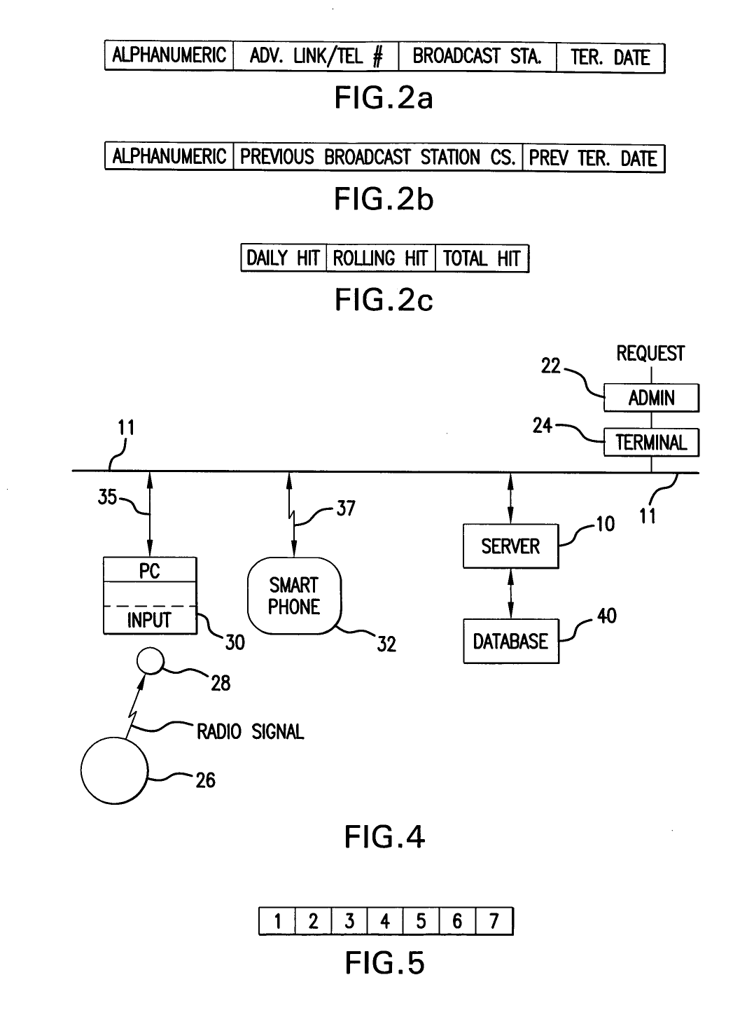

Referring now to FIG. 1 of the drawings, the system comprises a server 10 connected to the Internet 11. The server 10 has a URL address that allows it to be accessed via the Web. The server 10 may be (and typically would be) a component of a commercially available database hosting service. The server 10 includes a database indicated by the general reference number 14, which is managed by inputs from the server. In the illustrative embodiment of FIGS. 1 and 2, the database 14 includes a number of components. One component is a database file 16, illustrated in FIG. 2(a), of alphanumeric codes that have been assigned to an advertisement broadcast from a designated radio station or stations. Database file 16 links alphanumeric codes to a web address, or telephone number, or both that is related to a radio broadcast advertisement that includes the code as part of the audio broadcast. The database file 16 may also include text about the advertised product or service.

In a preferred embodiment of the invention, the code set includes a set of two and three character alphanumeric codes, “alpha numeric, alpha numeric numeric, and alpha, alpha, numeric”. That is, for example C3, B37, AB8. This format has several advantages. It is short and easy to remember when heard, easy to enter or write down, and in the specific application to radio broadcast advertisement, sufficiently unique the it can be come recognized for what it is. It will be appreciated that a three-character code has a limited number of unique codes. In the preferred code embodiment, there are only about 5,000 unique codes. In accordance with the teaching of this invention, the codes are reused while the URL of the server where the codes are stored and any application used to address the server remain unchanged.

In accordance with the teaching of this invention the code is linked to the radio broadcast advertisement. Radio broadcast advertisements are typically broadcast for a limited duration. When the advertisement is no longer being broadcast (or a short time thereafter), the code is denoted in the database as unassigned so that an input from a listener to the server with this unassigned code address does not return any information concerning the terminated ad.

To the end of allowing the reassignment of codes, the database 14 includes another component, database file 18 that includes a list of alphanumeric codes that are unassigned and thus available for assignment to an advertisement. A code from this list is assigned to a new advertisement and, when an advertisement stops running, the code from the terminated advertisement is returned to the list. FIG. 2(b) illustrates the data included in the file 18. This includes the radio station broadcasting an advertisement to which any code previously had been assigned and preferably the date the previous advertisement stopped running. As will be appreciated by those skilled in the art, a radio station has a limited area in which its' broadcast signal is received. This area depends upon its' broadcast license, which in turn limits the signal strength, broadcast antenna location, and other factors. Thus a code to an advertisement broadcast by a station in one area can be assigned to an ad running in another broadcast area where the areas in which the respective broadcasts are received do not overlap. A code assigned to an advertisement broadcast by a station in Washington D.C. can be reassigned to an advertisement broadcast by a station in San Francisco almost immediately after it has stopped running in D.C., without risk of listener confusion, since there is no overlap in the broadcast areas.

The server 10 maintains a file 20 of the number of requests (hits) received for each code. This allows the generation of a report to the advertiser indicating the effectiveness of the use of cods in its ad, and also provides an indication that an advertisement has stopped being broadcast when requests stop being received.

A request for assignment of a code comes to an administrator 22 who has a terminal 24 connected to the server 10 via the Internet 11. The request can come via email, telephone, regular mail, or verbally. The request will typically provide, in addition to the advertiser's web link and/or telephone number, the date when the advertisement will stop being broadcast and the stations that will be broadcasting the ad. The available codes in the database 18 can be accessed by the administrator and displayed on his or her terminal 24. From the available codes, the administrator selects a code and assigns it to the advertisement. The administrator enters the code in the database 16 along with the web link and/or telephone number of the advertiser, the station(s) that will broadcast the advertisement and the date the advertisement will stop running. When the advertisement stops running, the administrator will remove the code and its associated data from database 16 and return the code to database 18 along with the data indicating the station(s) that had just broadcast the advertisement and when it stopped running. Thus when the administrator examines database 18 for available codes, he or she can determine the broadcast area where a code was last used and assign the code to a new advertisement only if it is to be broadcast in an area that is non-overlapping with an area where the code was recently used. It will be appreciated that broadcast station and advertisement termination dates for the last several uses of the code can be stored in database 18 to further insure there is no overlap. For example, the data can be kept in database on a rolling one-year time basis.

Referring now to FIG. 2 in addition to FIG. 1, FIG. 2(a) illustrates typical data fields in the database file 16. These include the code field assigned to an advertisement, a web link, or telephone number, or both associated with the advertisement, the station(s) that will broadcast the ad, and when the advertisement will stop running. As will be appreciated by those skilled in the art, the stations broadcasting the advertisement and the advertisement termination date could be stored in a separate database with the assigned code. FIG. 2(b) illustrates typical data fields in the database file 18 where the list of available codes is stored along with fields indicating broadcast stations where they have been used previously and the date of termination of the previous ad. In one embodiment of the invention, a field (not shown) can be added ranking the particular code in terms of its desirability in terms of length and perhaps ease of recall. For example A1 is shorter and presumably easer to recall than GH7. FIG. 2(c) illustrates the fields in the file 20 that includes the code, the number of requests per day over a running period (e.g. 14-day period) and the total cumulative requests to date.

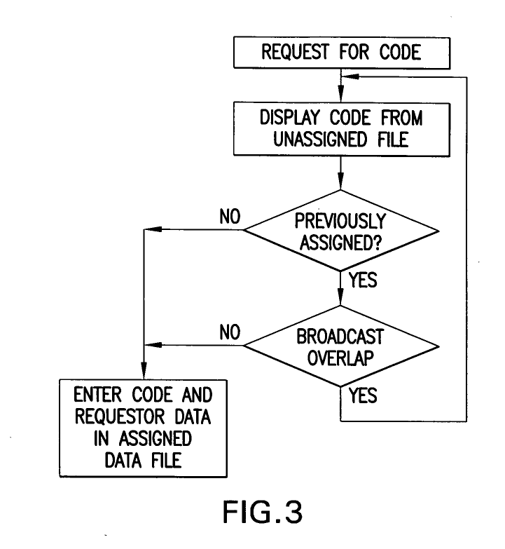

Referring now back to FIG. 1 and in addition to FIG. 3, which outlines a typical series of steps in the operation of this invention, a requestor requests the assignment of a quick recall alphanumeric code from an administrator 22 for a radio advertisement that is to be (or is being) broadcast. The requestor could be the advertiser, its agent, or the broadcaster for example. The administrator could be an automated system, or a person with a computer terminal 24 that can access and enter data into the system and communicate with the requester, for example via email. The request preferably includes, the information as to the station or stations that will broadcast the ad, the duration during which the advertisement will be broadcast, and the information (e.g. web link, telephone number, product/service data) to be linked to the quick recall code. The administrator calls up the available codes from the database 18, and selects one or more suitable codes (e.g. geographic separation from last use). Once a code has been selected, the administrator enters the code along with the data of the advertiser into the database 16.

The server 10 is connected to the Internet, and has a URL web address. A radio station 26 broadcast the advertisement along with its assigned quick recall code. The person 28 hearing the code, accesses the server 10 via a pc 30, or mobile wireless device 32, such as a smart phone, and enters the alphanumeric code he or she heard. It will be appreciated that the URL address of the server 10 can be conveniently set up and stored on the person's pc or mobile wireless device as an application, so that simply accessing an icon makes the connection to the server. The server 10 accesses the database 16 at the data base address specified by the alphanumeric code and returns the web link and/or telephone number at that address to the requestor. For the sake of generality the pc 30 is illustrated with a hard-wired connection 35 to the Internet and the smart phone with a wireless connection 37. The server 10 can also be programmed to access the web link and send the data at the link web address to the requestor. Similarly, the server 10 can be programmed to place a call to the telephone number at code address and connect the call to the requestor's smart phone.

Referring now to FIGS. 4 and 5. The only difference between the embodiment FIGS. 4 and 5 and the embodiment of FIGS. 1 and 2 is the organization of the database. Here the server 10 makes use of a database 40 that has a table (group) of records with seven fields illustrated in FIG. 5. Field 1 is the alphanumeric code of three characters or less that is assigned to an advertisement. Field 2 is the name of the Company/Organization running the advertisement. Field 3 is the phone number (if any) that the advertisement is asking the listener to call. Field 4 is the URL Web site address that the advertisement is asking the listener to go to. Field 5 identifies the radio station(s) running the ad. Field 6 is the Stop date, the date the advertisement will stop running. Field 6 is the hit counter. It will be appreciated that it is not necessary to have a list of unassigned codes. The administrator can select an alphanumeric code and the system will reject if it is already assigned. However, if desired to quickly list unassigned codes, an eighth field can be added which can be set to TRUE if assigned and FALSE if unassigned. This field can be use to derive and display all the unassigned codes, from which the administrator can chose.

As will be appreciated by those skilled in the art, there are two programs hosted on the server 10 designed to access the database 14 or 40. A manager program accepts inputs from the administrator's terminal 24 and allows the administrator to add, delete, assign, and un-assign records in the database. A user program, also hosted on the server 10, processes alphanumeric codes address to the URL of the server 10 from the user device, such as a smart phone, or a computer terminal. If the user enters a valid, assigned code, data will be transmitted from the database at the code address and appear on the user's screen as an icon button or buttons. One will indicate the name of the organization running the ad. Clicking on the organization button will access the web site to which the advertisement directs the listener to contact. Where the advertisement includes a telephone number to contact, the telephone number will appear on the user's screen. If the user's device has telephone connectivity such as the Apple iPhone and similar devices, pressing the telephone number will place the call. For each access to a particular alphanumeric code address, the hit counter at that address is incremented. It will be further appreciated by those skilled in the art, the system described above can be easily using commercially available database management software tools, such as the data base management tools provided by Microsoft.

1. A system to help listener access an advertiser's advertised telephone number and/or web site for additional information, comprising in combination:
a server connected to the Internet, said server accessible via the Web at a Web address;
said server including a database, said database including code addresses in an unassigned status that are available for assignment to a radio broadcast advertisement;
said database also including code addresses in an assigned status that are assigned to a radio broadcast advertisement to be broadcast respectively in first geographic areas; said database including an advertiser telephone number and/or web address at the assigned alphanumeric code addresses;
said server accessing a code addresses in response a code address from a listener sent via the Internet and returning the telephone number and/or web address linked to the code addresses via the Internet;
said server including an administrator;
said administrator assigning to a requestor, in response to a request for an assignment, a code address;
said administrator transferring a code address from said assigned status to said unassigned status after a radio broadcast advertisement with which said code address is associated ends.

2. A system to help listener access an advertiser's advertised telephone number and/or web site for additional information as in claim 1 wherein said code addresses are two and three characters in length.

3. A system to help listener access an advertiser's advertised telephone number and/or web site for additional information as in claim 2 wherein said code addresses are alphanumeric characters.

4. A method to provide a listener access via the Internet to data related to a radio broadcast advertisement including the steps of:
providing a listener in a first radio broadcast area with Internet access at a Web address to first advertiser data at a address assigned to a radio broadcast advertisement broadcast in a first radio broadcast area; said first advertiser data including a link to a web site and/or a telephone number;
providing a listener in a second radio broadcast area, non-overlapping with said first radio broadcast area, with Internet access at said Web address to second advertiser data at said code address assigned to a radio broadcast advertisement broadcast in said first radio broadcast area; said second advertiser data including a link to a web site and/or a telephone number.

5. A method to provide a listener access via the Internet to data related to a radio broadcast advertisement as in claim 4 wherein said code addresses are two and three characters in length.

6. A method to provide a listener access via the Internet to data related to a radio broadcast advertisement as in claim 4 wherein said code addresses are alphanumeric characters.

7. A method to provide a listener access via the Internet to data related to a radio broadcast advertisement as in claim 5 wherein said code addresses are alphanumeric characters.

8. A method for providing, via the Internet, radio station listeners with information at an internet address, including the steps of:
broadcasting a code as part of a first advertisement broadcast by a first station whose broadcast is limited to a first area;
transmitting said code to said internet address in response to a listener input to said first advertisement;
broadcasting said code as part of a second advertisement broadcast by a second station whose broadcast area is limited to a second area that does not overlap with said first area;
transmitting said code to said internet address in response to a listener input to said second advertisement.

9. A method for providing, via the Internet, radio station listeners with information at an Internet address as in claim 8 wherein said first advertisement has stopped being broadcast prior to commencing broadcast of said second advertisement.

10. A method for providing, via the Internet, radio station listeners with information at an Internet address as in claim 8 wherein said code includes alphanumeric characters that are two and three characters in length.

11. A method for providing, via the Internet, radio station listeners with information at an Internet address as in claim 9 wherein said code includes alphanumeric characters that are two and three characters in length.
